(19) United States
(12) Patent Application Publication
(10) Pub. No.: US 2005/0144030 A1
(43) Pub. Date: Jun. 30, 2005

(54) System and method for territory based commission attribution

(76) Inventors: Vincent D. Mazza, Smithtown, NY (US); Arthur S. Pidd, Northport, NY (US)

Correspondence Address: KENYON & KENYON, 1500 K STREET, N.W., SUITE 700, WASHINGTON, DC, 20005, US

(21) Appl. No.: 11/000,049

(22) Filed: Dec. 1, 2004

Related U.S. Application Data
(60) Provisional application No. 60/525,824, filed on Dec. 1, 2003.

(51) Int. Cl. G06F 17/60

(52) U.S. Cl. 705/1

(57) ABSTRACT

A method and system for territory based commission attribution. According to one embodiment, a Web engine receives a request for information about a product from a user, binds the user to at least one of a plurality of agencies that support the product in a sales territory associated with the user, and submits a booking request for the user to a supplier of the product along with an identifier of the at least one bound agency for commission attribution.

### CROSS-REFERENCE TO RELATED APPLICATIONS

This application claims the benefit under 35 U.S.C. § 119(e) of U.S. Provisional Application No. 60/525,824, filed Dec. 1, 2003, which is hereby incorporated by reference in its entirety.

### BACKGROUND OF THE INVENTION

Marketing organizations for service industries generally advertise directly to consumers on national television shows, cable television, radio, newspaper, magazine, electronic mail, direct mail and billboards. In the travel industry, for example, sales leads from clients generated by such advertisements are forwarded to local agencies for fulfillment in their particular sales territories.

Fulfillment usually comprises the local agencies closing the sales themselves via traditional means (i.e., face to face appointments and/or by telephone). Once a client is “sold”, the agent needs to complete the transaction either over the phone to a supplier (e.g., cruise line, tour operator, other travel agency) or through a system such as the airline reservations systems. The agent then issues an invoice and provides documentation to the client for presentation to the product (e.g., cruise, tour).

In most cases, the documentation for cruises and tours come from the supplier to the travel agency. This process has a large cost not only to the supplier, but also to the travel agent who needs to redistribute the documentation out to the client, thus encountering mailing and labor costs associated with issuing the documents.

Accordingly, there is a need in the art for a system and method that reduces the cost and complexity associated with the fulfillment of sales leads.

### BRIEF DESCRIPTION OF THE DRAWINGS

FIG. 1 is a block diagram that depicts entities for territory based commission attribution in accordance with an embodiment of the present invention.

FIG. 2 is a sequence diagram that depicts a process for territory based commission attribution in accordance with an embodiment of the present invention.

FIG. 3 is a block diagram that depicts an attribution system in accordance with an embodiment of the present invention.

FIG. 4 is a design diagram for a process of binding a user to an agency in accordance with an embodiment of the present invention.

FIG. 5 is a block diagram that depicts an agency evaluation matrix in accordance with an embodiment of the present invention.

FIG. 6 is a block diagram that depicts a user computing device in accordance with an embodiment of the present invention.

FIG. 7 is a block diagram that depicts a network architecture in accordance with an embodiment of the present invention.

### DETAILED DESCRIPTION

In accordance with the present invention, a more straightforward and cost-effective way for fulfilling sales leads may be accomplished by distributing closed sales electronically to a supporting agency (e.g., based on its sales territory), rather than distributing sales leads to the agency.

For example, a Web engine may walk a consumer through the entire sales process up to and including the final payment of a vacation. Based on the consumer's zip code, the engine may determine the nearest agency and then confirm the reservation directly with the supplier under that agency's name. This process not only allows the consumer who wants to purchase online to do so, but it also provides the consumer access to a real live travel agent in the consumer's local area to assist them with any other part of their trip.

As a result, the travel agency earns the full commission on the reservation in which the agent had no involvement, aside from an association with the Web engine owner (e.g., as a licensee for a particular sales territory). This additional revenue helps that agency qualify for higher commission payments since the sale will be counted under the agency's total revenue with a particular supplier. (Commission scales are normally determined by an agency's volume with a particular supplier; it's usually revenue based, but sometime passenger based.)

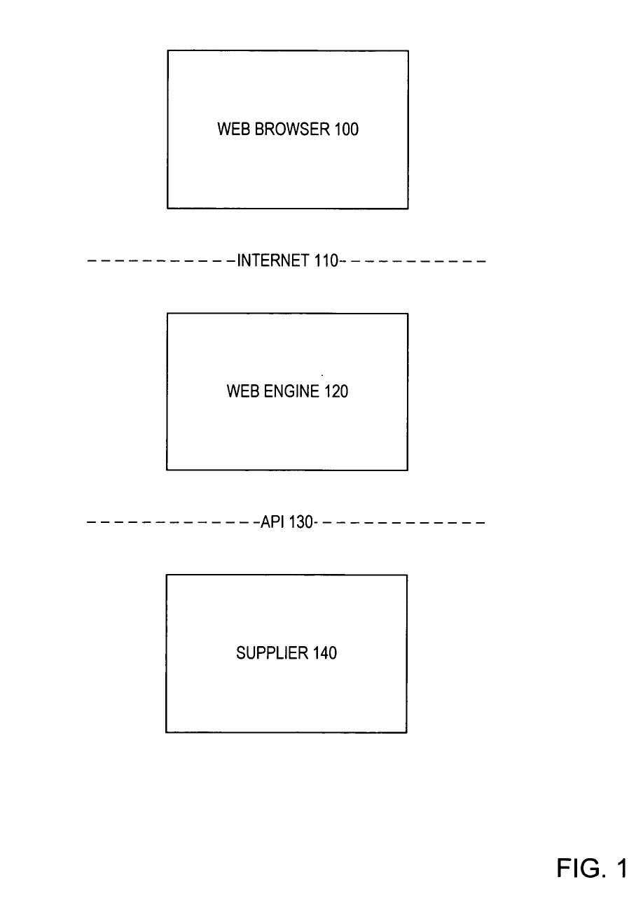

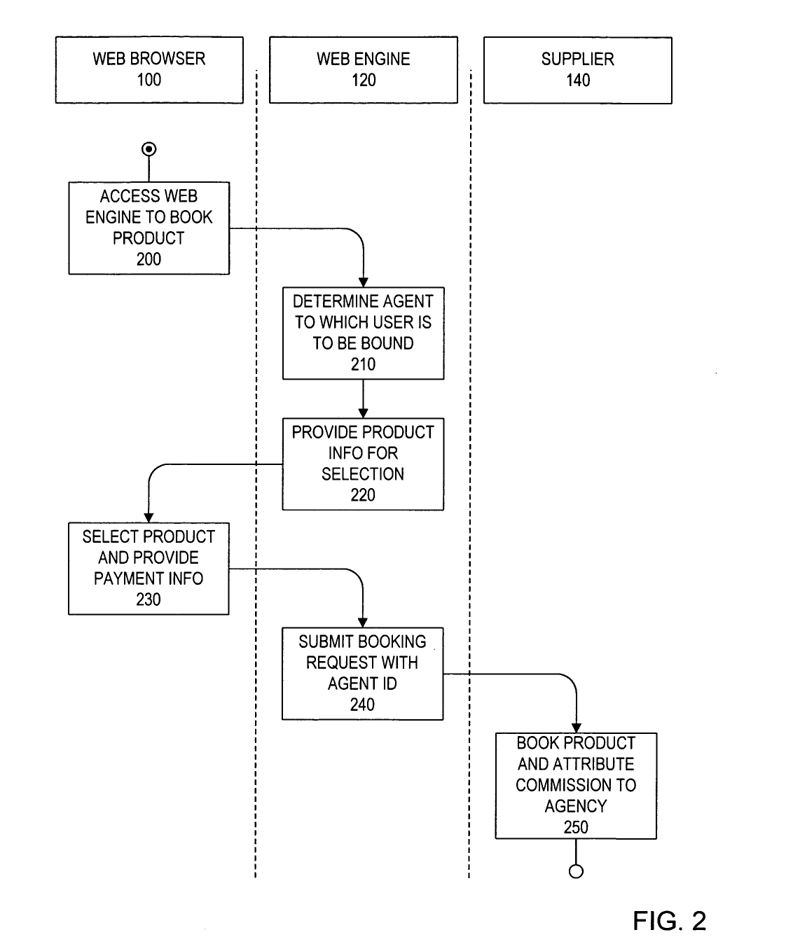

FIGS. 1 and 2 depict such a process in accordance with an embodiment of the present invention. FIG. 1 illustrates an arrangement of Web browser 100, Web engine 120 and supplier 140. A user (e.g., consumer) may operate Web browser 100 to access Web engine 120 over the Internet (120) to peruse product (e.g., goods or services) information. Web engine 120 may render the product information based on content provided by supplier 140 via direct connections through a supplier provided Application Programming Interfaces (API 130). Web engine 120 and supplier 140 may be independently owned, or owned and/or operated by the same entity.

As shown in FIG. 2, when the user operates Web browser 100 to access Web engine 120 to book (e.g., reserve, purchase, etc.) a product (step 200), Web engine 120 determines which agent that can support the product is to be bound to the user (step 210). Once this determination is made, Web engine 120 provides product information (step 220) which the user may select and pay for via Web browser 100 (step 230). Upon receiving the payment information, Web engine 120 submits a booking request to supplier 140, along with the user information (e.g., personal information, payment information, etc.) and an identifier for the agency to which the user is bound (step 240). Upon receipt of this information, supplier 140 books the product and attributes the resulting commission to the identified agency (step 250).

In step 210, if the user is not bound to a particular agent, then the user may be directed to an agency finder page to enter information such as name, desired login information, postal address and other optional information. If the user is already bound to an agency, then the particular agency identification may be attached to the user session information as the user continues to the next step in the booking process. The user session information may be maintained in a session xml document on Internet Web servers. The agency identification may be returned from the agency finder and cross-referenced in a local data table to the specific agency identification assigned by and used by the particular supplier selected by the user.

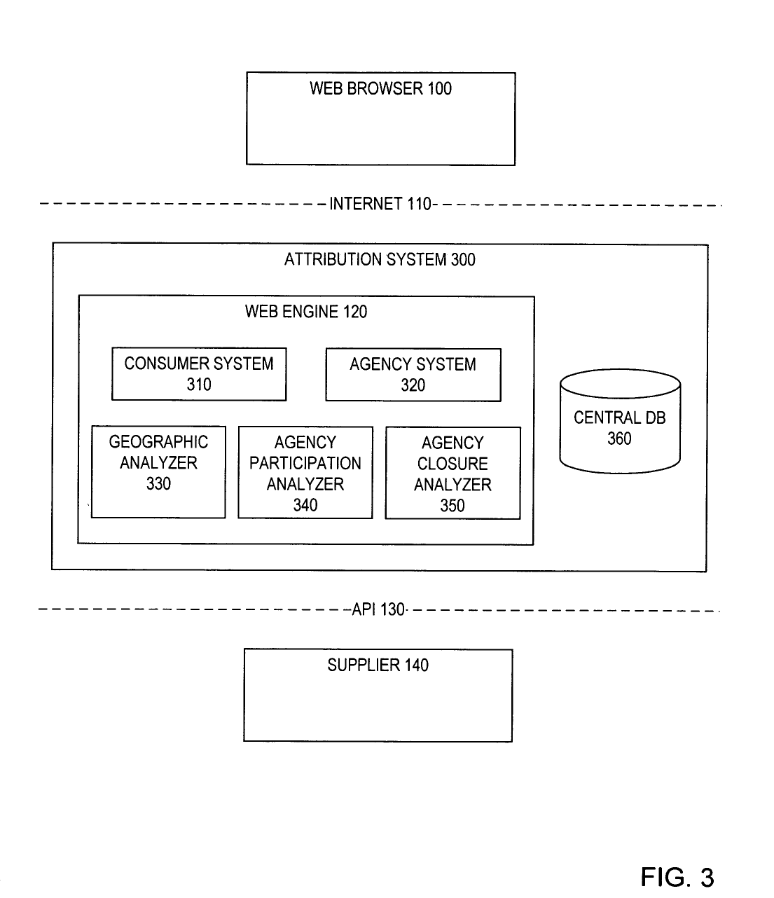

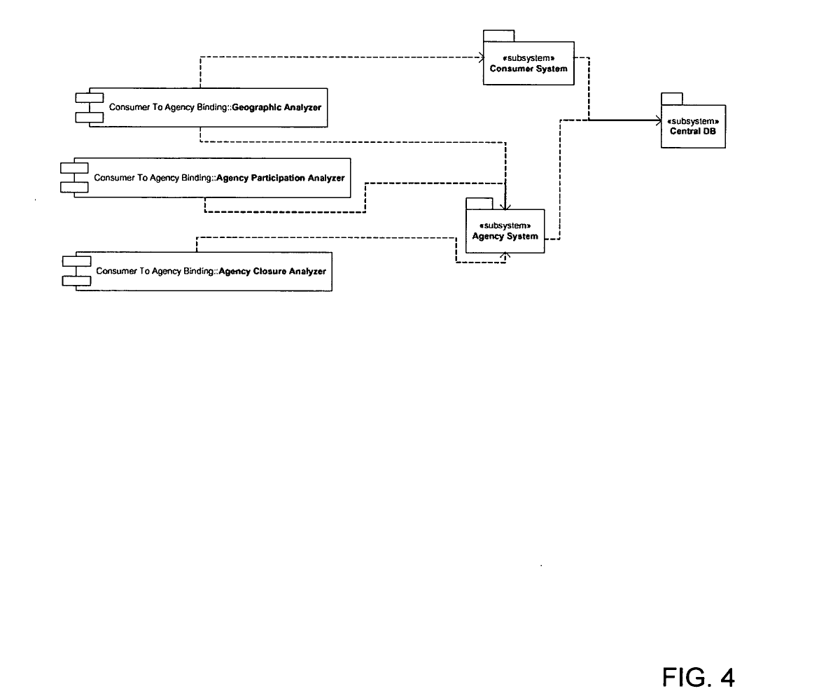

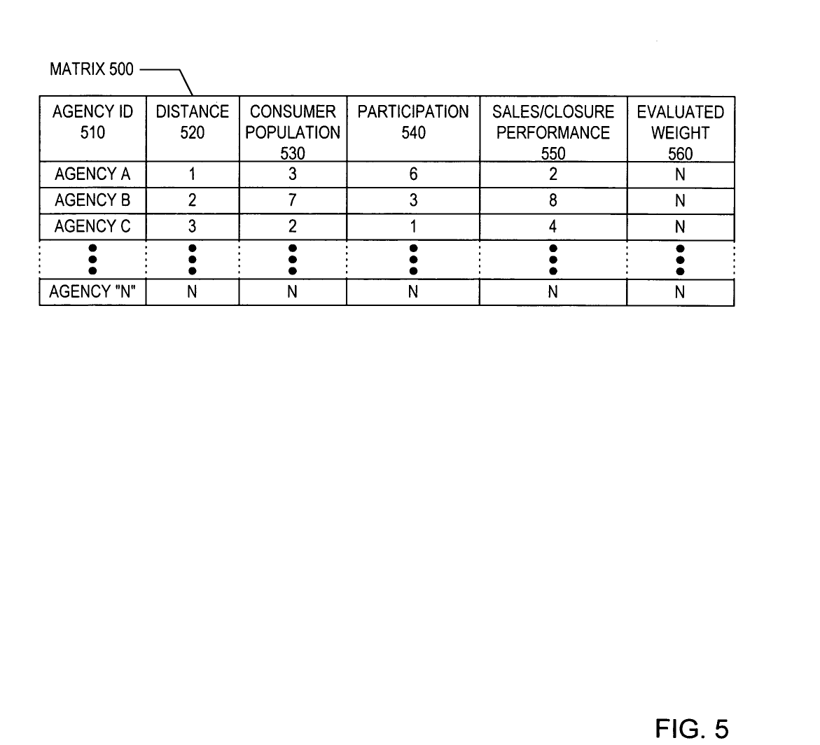

FIGS. 3-5 provide a more detailed view of the agency binding process (step 210) in accordance with an embodiment of the present invention. FIG. 3 illustrates the components of attribution system 300, which comprise Web engine 120 and central database 360. Web engine 120 comprises consumer system 310, agency system 320, geographic analyzer 330, agency participation analyzer 340 and agency closure analyzer 350. FIG. 4 shows a UML design for the process of binding a user to an agency via these components, each of which manipulate an agency matrix (FIG. 5) that identifies the agency (or agencies) that is best suited to meet the user needs and provide the highest commission for the agency.

In accordance with the above embodiment, geographic analyzer 330 calculates a list of agencies that are within a predetermined radius of the user's location, and populates the agency matrix with the findings. Agency participation analyzer 340 calculates production/revenue, determines an agency usage of a company's services and marketing programs across all applications within the organization (e.g., an independently or wholly owned travel agency chain, or travel agency franchise), and weights the matrix with the collected information. Agency closure analyzer 350 looks into the actual transactions that were fully completed as opposed to transactions that were just quoted, and weights the matrix based on these findings.

After all the analyzers have run, the agency with the highest rating determines the agency for the user. Once determined this agency is the agency of record for all transactions pertaining to the user for the given application.

Consumer system 310 may comprise entity objects that encapsulate a user, the address of the user, etc. Each object may have its own set of validation rules that are embedded inside of the object. Consumer system 310 may also be divided into multiple class libraries, which may be designed to be pluggable. For instance, if a client (e.g., supplier, agent, etc.) wants to communicate through a Web service, the only change needed would be a line in a configuration file. If the client wanted to communicate directly, the same line need only be changed to the appropriate user object. The use of a Web service and the use of pluggable interfaces allows for the distribution of the client interface without distributing the core intelligence of the operation.

Agency system 320 is based on the same premise as consumer system 310. Agency system 320 may comprise entity objects that encapsulates an agency and relevant information pertaining to the agency. Agency system 320 may also implement the pluggable interface for communication.

Central database 360 may house all the data that is collected from the component systems. This database may be a standard relational SQL system.

In accordance with the above embodiment, FIG. 5 depicts an agency evaluation matrix (matrix 500) which comprises an “n rows by 5 columns” table (excluding the weight column) in memory that accumulates results from each of the agency candidacy selection (analyzer component) processes. “n” is the number of agencies and each of the five columns correspond to the agency identification, distance, consumer population distribution, participation, sales closure performance values.

The agency id 510 field represents those agencies associated with attribution system 300 to which a user may be bound for commission attribution. The distance 520 field represents a ranking based on an agency's physical distance from a user. The consumer population 530 field represents a measurement that dynamically balances users to agencies where there is a high concentration of consumer population versus the number of member agencies in close proximity to each other. This can be considered the agency's virtual territory. The participation 540 field represents a qualitative measurement which allows more consideration to be placed for an agency that more fully participates in a company's services and marketing programs. The sales/closure performance 550 field represents the number of actual sales divided by the number of leads; for example, 2 sales/4 leads=0.5 or 50% closure.

Regarding the evaluated weight 560 field, once matrix 500 is evaluated and an agency is selected, an update is made to central database 360 to record the agency and user binding association and to trigger updates in the backend processing. During the evaluation process there may be predetermined weights applied to each matrix column that govern the column percentage of the whole. The selected agency then becomes the agency of record for transactions performed by the user and is credited with all commissions and overrides derived from the transactions.

Once the agency binding process is complete, the user may proceed to browse and select desired products (steps 220 and 230) in a normal fashion. For instance, the user may visit Web engine 120 to view and/or book a cruise or tour. A supplier selection Web page may allow the user to choose travel type by supplier (e.g. cruise line or tour operator), travel destination and target dates for travel. The available selections may be biased and constrained by the integration of preference information obtained from the bound agency's profile in central database 360. The agency has limited control of travel supplier and product offering which best suits business objectives and profitability (e.g., to list a specific cruise line's sailings first because the negotiated commissions are higher for the agency). Central database 360 may include database tables, agency profile tables, user profile tables, supplier tables, miscellaneous lookup tables, system tables, etc.

By the supplier selection Web page the user may be presented with a list of available sailing for cruises or available tour packages if a tour was selected for the targeted departure dates. Based on the browsing of provided information web pages, the user selects a specific sailing (a specific ship sailing on a specific date) or tour package of interest. The information web pages may include a series of web pages for informational purposes: ship photos, deck plans, basic itineraries, tour photos, ship comparisons, etc.

Tour packages may include two or more components (e.g., air and hotel, air and car and hotel, air and transfers) that are bundled together and offered on one packaged price/offering. There is usually a price break to the user because the user is bundling specifically negotiated rates together that may only be used in a “package” (transfers are usually bus or taxi from one place to another without renting a car—usually from the airport to a resort).

For a cruise booking, the user may choose from a list of available categories for the sailing. For a tour package the user begins selecting options with the tour package, usually beginning with the hotel selection. The available selections presented to the user again may be biased, constrained or augmented by information in the agency profile, supplier biasing information and miscellaneous information stored within central database 360.

For a cruise booking, the user may then be presented with a list of available cabins based on the sailing and category selected. Using information web pages detailing the available cabins, the user may select a cabin to book. For a tour package, the user may be presented with a list of hotel room categories such as Ocean View, Balcony, Deluxe, Suite, Standard Double, etc., to choose from within the specific tour package available option list. Information web pages may include a series of web pages for detailed information on cabins and tour packages: cabin photos, cabin location deck plans, detailed sailing itinerary, tour photos, city information, sites to see, restaurants, etc.

When a cabin is selected it is held out of live inventory by the cruise line and may not be booked by anyone else for a specific time period specified by the cruise lines (e.g., 15 minutes). If the booking of the cabin is not completed with this time period then the cruise line will release the hold and the cabin becomes available to book in the cruise line—possibly by someone else. In general, 15 minutes is more than adequate time to complete the booking process, as the most of the research has already been done to get to this stage of the booking.

Once the product is selected, the user may be presented with Web pages for collecting information about the user (or passenger, abbreviated “PAX” in travel industry terminology). These pages may operate under SSL secure socket layer for protection of user information. Credit card information may be passed on though secure channels to suppliers and not retained on local systems.

The user may then be presented with Web pages for collecting user selection of special services such as prepaid gratuities and special occasions like birthdays and honeymoons. Default complimentary items are automatically included as specified by the agency in the agency profiles in central database 360, such as complimentary bottle of Champaign or chocolate.

The user may then be presented with Web pages for providing the user with the ability to select from pre and post tour availability. For example, the user may choose to leave a few days early or stay a couple of days after the cruise and stay at a particular hotel prior to the cruise and/or after the cruise. Information web pages display hotel photos, city information, restaurants, places of interest, etc.

Once the user has entered all required information, a booking summary may be displayed for review. The user then makes the final confirmation for purchase.

Upon receiving this confirmation, Web engine 120 submits the booking information to the cruise line or tour operator (step 240). The agency identification is sent along with the consumer information to supplier 140 as the agency of record for the booking. This entitles the agency to all applicable credits, bonuses and commissions. The booking may be recorded and processed in central database 360 under agency identification and available to the agency through the agency's interface to attribution system 300.

The booking summary and confirmation may be displayed to the user with an option to email the user an agency and supplier branded custom information package detailing the booked cruise or tour from the consumer profile, booking record, agency and supplier profiles in central database 360.

Regarding airfare products and booking, Web engine 120 may link to a separate negotiated airfare database (which may then link directly to an airline to book the negotiated air), through a GDS (Global Distribution System) connection, through another agency consolidating airfare contracts or to the cruise line/tour operator to book their airfare, whichever is cheaper or has better schedules for the user. (GDS is the traditional reservation system an agency uses to make and track bookings.)

Additional features of the present invention may include user product availability and packaging that may be matched against user profile data collected via clickstream behavior, historic purchases and stored preferences. Click stream behavior, historic purchases and other data collected is analyzed and a value is generated for the agencies in the same territory. It provides information to assist in balancing the distribution of users being bound to an agency. This may be applied to home based agents and virtual population territories. (Virtual population territories may comprise the same population area as a specific geographical territory, but with a count large enough to allow for more than one agency. The profile data collected may be analyzed and a value generated for the agencies in the same territory; it provides information to assist in balancing the distribution of consumers being bound to an agency.) Control of the packaging process may include rules that bias supplier products through information concerning agent's negotiated prices or service agreements, combinations of connectivity to internally stored data, direct data links to suppliers and agency information systems. Supplier product inventory image may be maintained locally to continue to provide product at times when the connectivity to live inventory may be inoperable.

As mentioned above, an expert agency finder may utilize statistical processes to select the agents to best close a sale of a travel product based on demonstrated ability to sell the specific product or product niche through dynamic numerically based evaluation of the agent's statistical closure performance along with other detailed statistical metrics that include business rules (e.g., consumer population distribution, participation, etc.). Tracking mechanisms to measure performance and closure rates can also be explained and can be used in association with stretched goals, incentive programs and rewards.

Additional features may include reporting (the ability for individual agents to review all sales they made and then run various reports by revenue, cruise line, etc., the ability for agencies owners/managers to review all sales made by their agency and produce the same vendor and client reports, and the ability for travel agency chain HQ to see rolled up reports of production by agency with break outs by supplier), brochures (creating electronic brochures dynamically), connectivity (direct to vendor via VPN and/or www), e-mail (e-mail cruise comparisons/options to user and provide the functionality for user to book themselves online from the options sent or call agency to purchase over the phone, e-mail follow up/welcome home e-mails to clients and also survey them on their trip, allow an agency to create e-mail campaigns using client information/demographics and allow information to be exported to use for snail mail campaigns), CRM (storing information on all bookings made within system and allowing an agency to input client data manually into system), “sales shifter” (controlling availability and bias based on preferred supplier goals and sales targets), “cruise consolidator” (consolidating sales from agencies with low commissions on cruise lines and through volume based commission agreements, pay agencies a higher commission on lines where they only make the base commission—via electronic bookings), and “group sales consolidator” (blocking group space and opening up the group rates to agencies on individual sailings, keeping tour conductors for home office, paying out higher commission—via electronic bookings).

Further features may include the ability to mark up net fares or discount base fares for leisure products, marketing tools and revenue-management capabilities, the ability to build Passenger Name Records from the client profile database, completing transaction reporting for bookings, sales and commission, customer relationship management (CRM) tools, the ability to build and export lists to direct mail or e-mail programs, the ability to sell and track commissions, reducing office space using home based agents, and no GDS contract needed, eliminating GDS costs.

Regarding customer profiles, client data, itineraries and preferences may be stored in a secure database for maintaining account information such as address, telephone, fax number, passenger list, billing data seating preferences, frequent-flyer numbers, special meal requirements, credit card number, E-mail address and much more. A Passenger Name Record (PNR) item lets the user transfer stored data to a PNR, edit information, add remarks and complete the process in standard GDS/CRS language.

Regarding “Ticklers” (i.e., payment/deposit manager), agents may be allowed to set reminders in the system to call back or follow up with customers. Some reminders, such as cruise final payment or failed credit card authorizations may be automated.

Regarding reservation, searches may be conducted by cruise line, cruise ship, date range, destination, embarkation port and port of call. The system may enable an agent to hold a cruise reservation, extend or modify the hold, discount the base fare, enter coupon data, enter bonus commission data, make payments against the hold, modify the PNR and enter document-shipping information into the record.

Regarding insurance bookings, in order to provide an additional revenue source, the system may book insurance electronically through Access America, CSA and Trip Assured, for example.

Regarding upsell promptings, the system may prompts agents to upsell. The agent may click on a live deck plan that highlights open cabins, and notes exactly what kind of upgrade they can offer their clients for exactly how much more money.

Regarding a superfast booking mode, the system offers the flexibility to meet the cruise booking and management needs of both novice and seasoned travel agents. It allows experienced agents to set a streamlined search and booking version of the system as a default, and is a superfast mode for agencies that are run more like call centers. Processing is speeded up dramatically, and with a faster turnaround time, agents can close even more cruise business.

### Architecture

Sales territories may be tracked through a suite of robust backend applications that maintain and manage the relationships between Web engine 100 and the associated agencies and suppliers. By passing the agency id with the booking, the suppliers see the booking exactly the same way as if the agency performed the booking directly even though the agency may have been hands off during the whole process. The suppliers may subsequently be responsible for commissions and other credits due to the agency and process them in a normal fashion. Internally, central database 360 may maintain a record of each booking with the agency of record for that booking. Since this information is stored internally, it may be included to management programs for reporting and agency/supplier production verification.

As mentioned above, connectivity to supplier 140 may be made with direct connections through a supplier provided API. Each API may be wrapped in an independent interface module which may be dynamically found and instantiated by an API factory within the controller module implemented as a Web service. The architecture may use a XML and SOAP standards based messaging structure to communicate through the web service to the request/response presentation layers decoupled from the plurality of heterogeneous and specific interfaces to direct supplier inventory.

Additionally, a queue management system may handle requests for inventory, which monitors the API condition and upon operational status will attempt to pull the inventory item for a specified period of time for purchase and notify the user of the event via the Web site of Web engine 120. The user then has the opportunity to complete the purchase and close the transaction. If the time expires before the consumer finalizes the request then the product will be release back into supplier inventory.

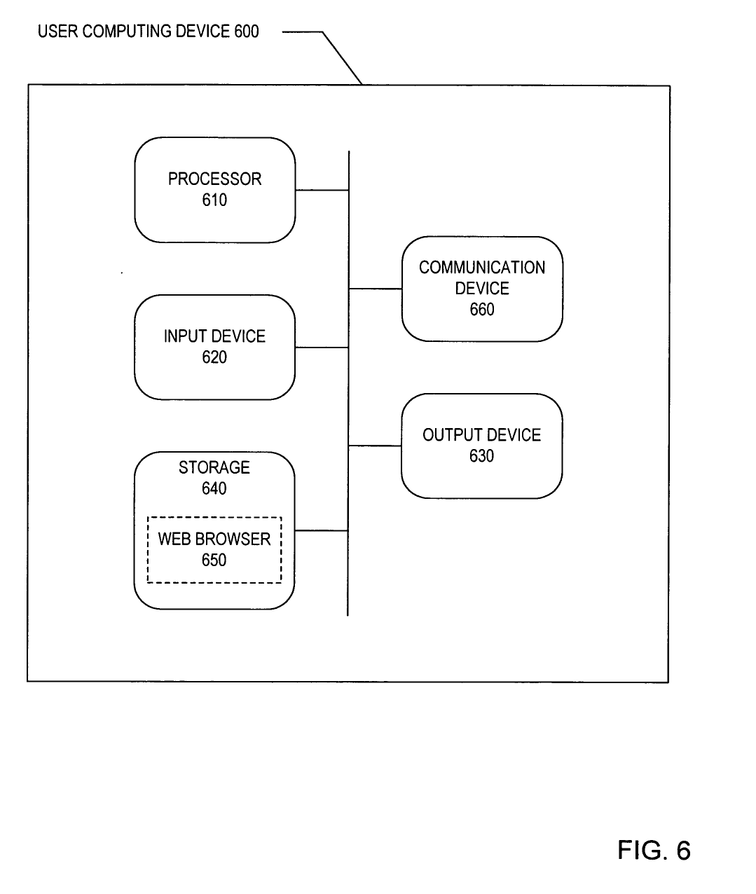

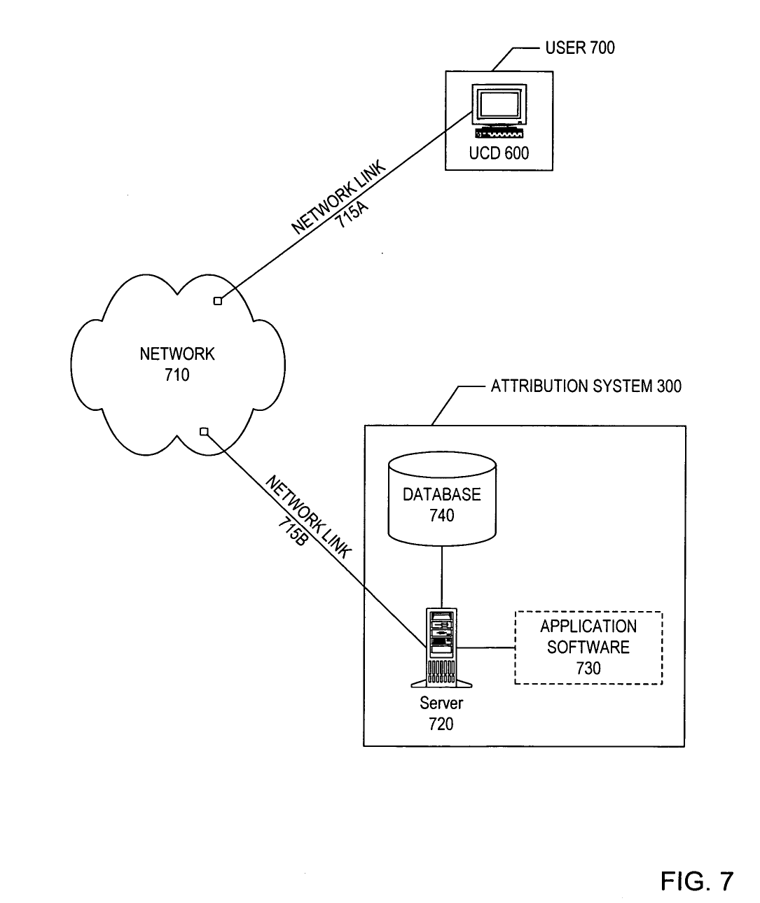

FIGS. 6 and 7 illustrate the components of a basic computer and network architecture in accordance with an embodiment of the present invention. FIG. 6 depicts user computing device 600, which may be a personal computer, workstation, handheld personal digital assistant (“PDA”), or any other type of microprocessor-based device. User computing device 600 may include one or more of processor 610, input device 620, output device 630, storage 640, and communication device 660.

Input device 620 may include a keyboard, mouse, pen-operated touch screen or monitor, voice-recognition device, or any other device that provides input. Output device 630 may include a monitor, printer, disk drive, speakers, or any other device that provides output.

Storage 640 may include volatile and nonvolatile data storage, including one or more electrical, magnetic or optical memories such as a RAM, cache, hard drive, CD-ROM drive, tape drive or removable storage disk. Communication device 660 may include a modem, network interface card, or any other device capable of transmitting and receiving signals over a network. The components of user computing device 600 may be connected via an electrical bus or wirelessly.

Web browser 650, which may be stored in storage 640 and executed by processor 610, may include, for example, Internet Explorer by Microsoft Corp. or Communicator® by Netscape Communications Corp., or any other software program that renders Web content (e.g., Web browser 100).

FIG. 7 illustrates a network architecture in accordance with an embodiment of the present invention. According to one particular embodiment, when the user accesses attribution system 300, Web browser 650 of user computing device 600 communicates with application software 730 (e.g., Web engine 120) of server 720 via network link 715a, network 710, and network link 715b.

Network links 715 may include telephone lines, DSL, cable networks, T1 or T3 lines, wireless network connections, or any other arrangement that implements the transmission and reception of network signals. Network 710 may include any type of interconnected communication system (such as the Internet), which may implement any communications protocol (such as HTTP), which may be secured by any security protocol (such as HTTPS).

Server 720 includes a processor and memory for executing program instructions as well as a network interface, and may include a collection of servers. In one particular embodiment, server 720 may include a combination of servers such as a web application server and a database server. Database 740 may represent a relational or object database (e.g., central database 360), and may be accessed via a database server.

User computing device 600 and server 720 may implement any operating system, such as Windows or UNIX. Application software 730 may be written in any programming language, such as C, C++, lava or Visual Basic, and may comprise the software implementing the TRAVELSAVERS CruiseXpressPRO booking and management solution.

In other embodiments, application software embodying the functionality of the present invention may be deployed on a standalone machine or through a client/server arrangement, for example.

Several embodiments of the invention are specifically illustrated and/or described herein. However, it will be appreciated that modifications and variations of the invention are covered by the above teachings and within the purview of the appended claims without departing from the spirit and intended scope of the invention.

1. A computer-implemented method for territory based commission attribution, comprising:
receiving a request for information about a product from a user;
binding the user to at least one of a plurality of agencies that support the product in a sales territory associated with the user; and
submitting a booking request for the user to a supplier of the product along with an identifier of the at least one bound agency for commission attribution.

2. The method of claim 1, wherein the request for information is received at a Web engine.

3. The method of claim 2, wherein the owner of the Web engine is not the supplier.

4. The method of claim 2, wherein the owner of the Web engine is the supplier.

5. The method of claim 1, wherein the product is a good.

6. The method of claim 1, wherein the product is a service.

7. The method of claim 1, wherein the product is a vacation package.

8. The method of claim 7, wherein the vacation package is a cruise booking.

9. The method of claim 7, wherein the vacation package is a tour package.

10. The method of claim 1, wherein the binding is based at least in part on the proximity of each of the plurality of agencies to the user's location.

11. The method of claim 1, wherein the binding is based at least in part on the amount by which each of the plurality of agencies participate in services and marketing programs of the supplier.

12. The method of claim 1, wherein the binding is based at least in part on the rate by which each of the plurality of agencies complete transactions as opposed to only quote transactions.

13. The method of claim 2, further comprising attaching the identifier of the at least one bound agency to session information associated with the user.

14. The method of claim 13, wherein the session information is maintained in a session xml document at the Web engine.

15. An apparatus for territory based commission attribution, comprising:
a processor; and
a memory, coupled to the processor, storing instructions adapted to be executed by the processor to:
receive a request for information about a product from a user,
bind the user to at least one of a plurality of agencies that support the product in a sales territory associated with the user, and
submit a booking request for the user to a supplier of the product along with an identifier of the at least one bound agency for commission attribution.

16. A system for territory based commission attribution, comprising:
means for receiving a request for information about a product from a user;
means for binding the user to at least one of a plurality of agencies that support the product in a sales territory associated with the user; and
means for submitting a booking request for the user to a supplier of the product along with an identifier of the at least one bound agency for commission attribution.
